(19) United States
(12) Patent Application Publication
(10) Pub. No.: US 2011/0141314 A1
(43) Pub. Date: Jun. 16, 2011

(54) DOCUMENT CAMERA, APPARATUS AND METHOD FOR ADJUSTING BRIGHTNESS

(75) Inventors: Hsuan-Hung LIU, TAIPEI HSIEN (TW); Chun-Wei LU, TAIPEI HSIEN (TW)

(73) Assignee: AVERMEDIA INFORMATION, INC., TAIPEI HSIEN (TW)

(21) Appl. No.: 12/870,788

(22) Filed: Aug. 28, 2010

(30) Foreign Application Priority Data
Dec. 11, 2009 (TW) 98142517

(51) Int. Cl. H04N 9/68

(52) U.S. Cl. 348/234; 348/E09.053

(57) ABSTRACT

A document camera, an apparatus and a method for adjusting brightness are disclosed, wherein the apparatus includes a light module, a sensor and a digital signal processor (DSP). The sensor can capture image data. The digital signal processor can process the image data and retrieve a brightness value from the processed image data, so as to adjust a light-emitting brightness of the light module according to the brightness value.

### RELATED APPLICATIONS

This application claims priority to Taiwan Application Serial Number 98142517, filed Dec. 11, 2009, which is herein incorporated by reference.

### BACKGROUND

1. Technical Field

The present disclosure relates to electronic devices, and more particularly, apparatus for adjusting brightness and application thereof.

2. Description of Related Art

Document cameras can be used in any Illumination condition and can adjust brightness of images through an auto-exposure function. Therefore, the output images with moderate brightness may be not affected by an environment light source.

As to the auto-exposure function, a processor generates an operation result based on the data that is acquired by a sensor and adjusts exposure time or RGB gain of the sensor according to the operation result. When the exposure time is increased, the brightness of the image is increased. Similarly, when the RGB gain is increased, the brightness of the image is also increased.

However, when the exposure time is increased, a frame rate (FPS) of the sensor is decreased to result in ghosts of dynamic images. When the RGB gain is increased, noise of the sensor is increased to result in noise disturbances of the output images, i.e. a signal-to-noise ratio is increased.

The document camera may have an assistant light source. If a user detected that the output images are dark, he or she would turn on the assistant light source.

Moreover, when the output images are dark, the exposure time and RGB gain of the sensor are adjusted to maximums. Thus, the frame rate of the dynamic image is slow, and the noise disturbances are serious.

When the assistant light source is turned on, it is need a lot of time to readjust an auto-exposure time because the exposure time and RGB gain achieves the maximums.

The conventional document camera is incapable of adjusting brightness of the assistant light source. When the environment light source is too bright, and when the assistant light source is not turned off, even if the exposure time and RGB gain of the sensor is adjusted to minimums; the output images will still be too bright.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more various aspects, the present disclosure is directed to document cameras, apparatus and methods for adjusting brightness.

According to one embodiment of the present invention, an apparatus for adjusting brightness includes a light module, a sensor and a digital signal processor (DSP). The sensor can capture image data. The digital signal processor can process the image data and retrieve a brightness value from the processed image data, so as to adjust a light-emitting brightness of the light module according to the brightness value. In this embodiment, the digital signal processor of the apparatus may adjust the light-emitting brightness of the light module through a pulse-width modulation.

According to another embodiment of the present invention, a method for adjusting brightness includes steps as follows. First, image data are captured. Next, the image data are processed and a brightness value is retrieved from the processed image data, so as to adjust a light-emitting brightness of a light module according to the brightness value. In this embodiment, the light-emitting brightness of the light module may be adjusted through a pulse-width modulation. Then, the processed image data are outputted to a projection device, so that the projection device projects an optical image.

According to yet another embodiment of the present invention, a document camera includes a light module, a sensor, a digital signal processor and an image output unit. The sensor can capture image data of an object. The digital signal processor can process the image data and retrieve a brightness value from the processed image data, so as to adjust a light-emitting brightness of the light module according to the brightness value. The image output unit can output the processed image data to a projection device, so that the projection device projects an optical image of the object. In this embodiment, the digital signal processor of the document camera may adjust the light-emitting brightness of the light module through a pulse-width modulation.

Technical advantages are generally achieved, by embodiments of the present invention, as follows:

1. The light-emitting brightness of the light module can be automatically adjusted to high or low according as brightness of the environment light source is low or high;

2. The brightness value retrieved from the processed image data stands for intensity of the brightness of the environment light source, so there is no need for any additional light detector to detect surrounding brightness;

3. In low illumination environment, a frame rate of the dynamic image is increased;

4. In low illumination environment, noise is reduced;

5. Electricity-saving is accomplished; and

6. The light-emitting brightness of the light module is adjusted through the pulse-width modulation, so as to extend a lifetime of the light module.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is a block diagram of an apparatus for adjusting brightness according to one embodiment of the present disclosure; and

FIG. 2 is a flowchart of a method for adjusting brightness according to another embodiment of the present disclosure.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawings.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In one aspect, the present disclosure is directed to an apparatus for adjusting brightness. The apparatus may be easily adapted to a document camera, and may be applicable or readily adaptable to all technology. In this apparatus, a digital signal processor adjusts brightness of a light module without regulating parameters relating to exposure time and RGB gain. In this way, it is no need to change the exposure time and RGB gain, so as to avoid decreasing a frame rate and increasing noise in low illumination environment.

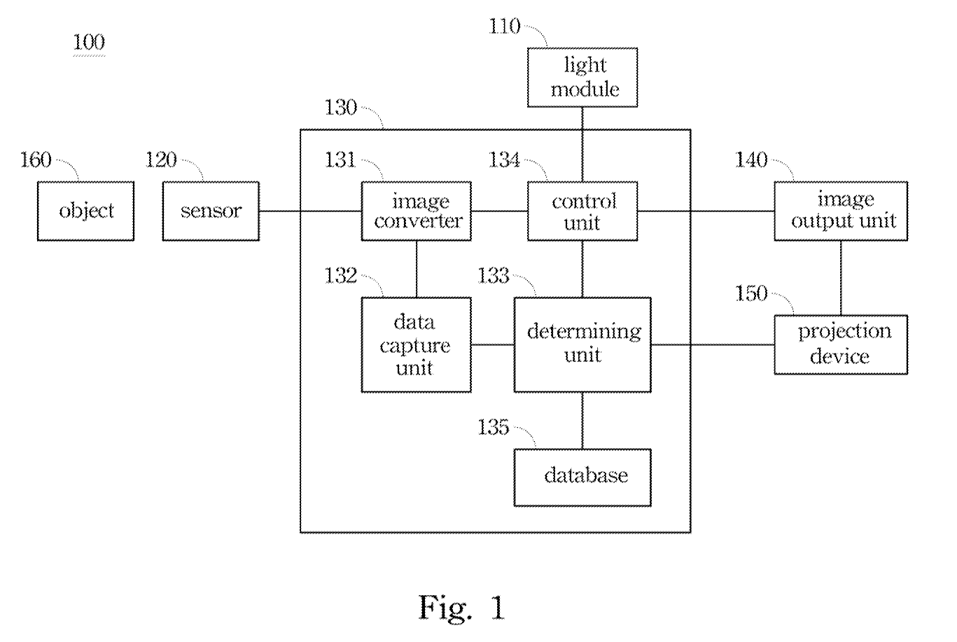

FIG. 1 is a block diagram of an apparatus 100 for adjusting brightness according to one embodiment of the present disclosure. As shown in FIG. 1, the apparatus 100 includes a light module 110, a sensor 120 and a digital signal processor 130. The sensor 120 can capture image data of an object 160. The digital signal processor 130 can process the image data and retrieve a brightness value from the processed image data, so as to adjust a light-emitting brightness of the light module 110 according to the brightness value.

Moreover, the apparatus 100 may include an image output unit 140. The image output unit 140 is electrically connected to the projection device 150. In use, the image output unit 140 outputs the processed image data to a projection device 150, so that the projection device 150 can project an optical image of the object 160.

For example, the image output unit 140 may be a digital-to-analog converter. The digital-to-analog converter can convert a digital image data into an analog image data, so that the projection device 150 can receive the analog image data. Moreover, the projection device 150 may be an optical projector or the like.

In one embodiment, the sensor 120 may be a light sensor, an image sensor or the like. The sensor 120 includes CCD or CMOS. The image data captured by the sensor 120 is RGB data, and the digital signal processor 130 includes an image converter 131 and a data capture unit 132. The image converter 131 can convert the RGB data into YUV data. The data capture unit 132 can retrieve the brightness value (Y value) from the YUV data.

In another embodiment, the image converter 131 can convert the RGB data into YCbCr data. The data capture unit 132 can retrieve the brightness value (Y value) from the YCbCr data.

For achieving moderate brightness, the digital signal processor 130 includes a determining unit 133 and a control unit 134. The determining unit 133 can determine whether the brightness value is within a predetermined brightness range. The control unit 134 can gradually adjust the light-emitting brightness of the light module 110 when the brightness value is not within the predetermined brightness range, so as to let the brightness value be within the predetermined brightness range. The brightness value within the predetermined brightness range stands for the optical image projected by the projection device 150 with moderate brightness. Therefore, the control unit 134 stops adjusting the light-emitting brightness of the light module 110 when the brightness value is within the predetermined brightness range.

The predetermined brightness range has a predetermined upper limit and a predetermined lower limit. The determining unit 133 can determine whether the brightness value exceeds the predetermined upper limit when the brightness value is not within the predetermined brightness range. When the brightness value does not exceed the predetermined upper limit, the control unit 134 can gradually increase the light-emitting brightness of the light module 110 until the brightness value is greater than the predetermined lower limit. Thus, the brightness value can be adjusted within the predetermined brightness range. Therefore, the optical image has moderate brightness.

Furthermore, the determining unit 133 can determine whether the light module 110 is turned on when the brightness value exceeds the predetermined upper limit. When the light module 110 is turned on, the control unit 134 can gradually decreases the light-emitting brightness of the light module 110 until the determining unit determines that the brightness value is lower than the predetermined upper limit when the light module is not turned off. In this way, the brightness value is adjusted within the predetermined brightness range. Therefore, the optical image has moderate brightness.

When the light-emitting brightness of the light module 110 is unceasingly decreased, the light module 110 may be turned off. When the light module 110 is turned off, the brightness value still exceeds the predetermined upper limit, which stands for the environment light source being too bright. Therefore, the apparatus 100 can be turned off.

With regard to the apparatus 100, those with ordinary skill in the art may flexibly select numerical values for the predetermined brightness range, the predetermined upper limit and the predetermined lower limit depending on the desired application. In practice, the predetermined brightness range depends on moderate brightness, so that the optical image projected by the projection device 150 is not too bright as well as not too dark. For example, the target brightness value corresponding to the moderate brightness is 100 lux, and the predetermined brightness range may be within about +/−10 percent of the target brightness value. Therefore, the predetermined upper limit is 110 lux, the predetermined lower limit is 90 lux, and the predetermined brightness range is from 110 lux to 90 lux.

In one embodiment, the control unit 134 may be a PWM unit. The PWM unit can send at least one pulse wave to the light module 110, so that the light module 110 controls the light-emitting brightness according to a pulse width of the pulse wave.

Alternatively or additionally, the digital signal processor 130 includes a database 135. The database 135 stores a lookup table, wherein the lookup table records the predetermined brightness range and a relation between the predetermined brightness range and at least one pulse width of a pulse wave. The determining unit 133 can determine whether the brightness value is within the predetermined brightness range. The control unit 134 can send the pulse wave based on the lookup table to the light module 110 when the brightness value is not within the predetermined brightness range, so that the light module 110 controls the light-emitting brightness according to the pulse width of the pulse wave, so as to let the brightness value be within the predetermined brightness range.

In another embodiments, the control unit 134 can adjusts the light-emitting brightness of the light module 110 by controlling current magnitude. Those with ordinary skill in the art may flexibly choose a brightness adjusting method from above embodiments.

The image converter 131, the data capture unit 132, the determining unit 133 and the control unit 134 may be hardware, software, and/or firmware. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

In another aspect, the present disclosure is directed to a method for adjusting brightness. The method may be easily adapted to a document camera, and may be applicable or readily adaptable to all technology. The method includes following steps:

(a) Image data are captured;

(b) The image data are processed and a brightness value is retrieved from the processed image data, so as to adjust a light-emitting brightness of a light module according to the brightness value; and

(c) The processed image data are outputted to a projection device, so that the projection device projects an optical image.

In step (a); the image data are RGB data. In step (b), the RGB data are converted into RGB data, and the brightness value (Y value) is retrieved from the YUV data.

For achieving moderate brightness, whether the brightness value is within a predetermined brightness range is determined in step (b). When the brightness value is not within the predetermined brightness range, the light-emitting brightness of the light module is gradually adjusted, so as to let the brightness value be within the predetermined brightness range. Then, when the brightness value is within the predetermined brightness range, adjusting the light-emitting brightness of the light module is stopped.

The light-emitting brightness of the light module can be adjusted through the pulse-width modulation. In one embodiment, at least one pulse wave is sent to the light module, so that the light module controls the light-emitting brightness according to a pulse width of the pulse wave.

Alternatively, a lookup table is preloaded in step (b), wherein the lookup table records a predetermined brightness range and a relation between the predetermined brightness range and at least one pulse width of a pulse wave. Then, whether the brightness value is within a predetermined brightness range is determined. Then, the pulse wave based on the lookup table is sent to the light module when the brightness value is not within the predetermined brightness range, so that the light module controls the light-emitting brightness according to the pulse width of the pulse wave.

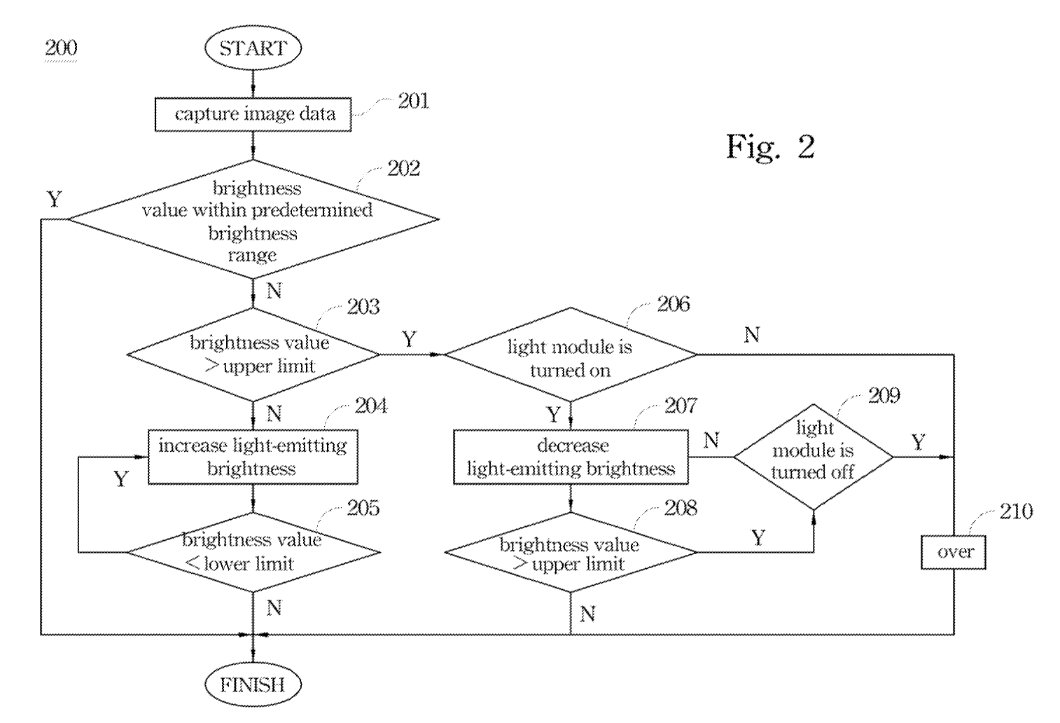

For a more complete understanding of the method for adjusting brightness, and the advantages thereof, please refer to FIG. 2. FIG. 2 is a flowchart of a method 200 for adjusting brightness according to another embodiment of the present disclosure. In FIG. 2, the method 200 includes steps 201-210 as follows (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

Image data are captured in step 201, so as to process the image data and retrieve a brightness value (Y value) form the processed image data. Then, whether the brightness value is within a predetermined brightness range is determined in step 202, wherein the predetermined brightness range is from a predetermined upper limit to a predetermined lower limit. When the brightness value is not within the predetermined brightness range, whether the brightness value exceeds the predetermined upper limit is determined in step 203. When the does not exceed the predetermined upper limit, the light-emitting brightness of the light module is gradually increased in step 204 until the brightness value is greater than the predetermined lower limit as determined step 205. Thus, the brightness value can be adjusted within the predetermined brightness range. Therefore, the optical image has moderate brightness.

When the brightness value exceeds the predetermined upper limit, whether the light module is turned on is determined in step 206. When the light module is turned on, the light-emitting brightness of the light module is gradually decreased in step 207. When the light module is not turned off as determined in step 209, the light-emitting brightness of the light module is still decreased gradually until the brightness value is lower than the predetermined upper limit as determined in step 208.

After the light-emitting brightness of the light module is increased by one energy level in step 204, step 205 is performed; then, step 204 is performed anew when the brightness value is lower than the predetermined lower limit. Therefore, if the brightness value were lower than the predetermined lower limit as determined step 205, in step 204 the light-emitting brightness of the light module would be increased by one energy level each time, which is so-called “gradually” increasing the light-emitting brightness. Similarly, after the light-emitting brightness of the light module is decreased by one energy level in step 207, steps 208 and 209 are performed; then, step 207 is performed anew when the brightness value is greater than the predetermined upper limit. Therefore, if the brightness value were greater than the predetermined upper limit as determined step 208, and if the light module was not turned off as determined in step 209, in step 207 the light-emitting brightness of the light module would be decreased by one energy level each time, which is so-called “gradually” decreasing the light-emitting brightness. Those with ordinary skill in the art may flexibly select a numerical value for the energy level depending on the desired application.

When the light-emitting brightness of the light module is unceasingly decreased in step 207, the light module may be turned off. When the light module is turned off in step 206, the brightness value still exceeds the predetermined upper limit, which stands for the environment light source being too bright. Therefore, the method 200 can be over in step 210.

With regard to the method 200, those with ordinary skill in the art may flexibly select numerical values for the predetermined brightness range, the predetermined upper limit and the predetermined lower limit depending on the desired application. In practice, the predetermined brightness range depends on moderate brightness, so that the optical image projected by the projection device 150 is not too bright as well as not too dark. For example, the target brightness value corresponding to the moderate brightness is 100 lux, and the predetermined brightness range may be within about +/−10 percent of the target brightness value. Therefore, the predetermined upper limit is 110 lux, the predetermined lower limit is 90 lux, and the predetermined brightness range is from 110 lux to 90 lux.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. An apparatus for adjusting brightness, the apparatus comprising:
a light module;
a sensor for capturing image data; and
a digital signal processor for processing the image data and for retrieving a brightness value from the processed image data, so as to adjust a light-emitting brightness of the light module according to the brightness value.

2. The apparatus of claim 1, wherein the image data captured by the sensor is RGB data, and the digital signal processor comprises:
an image converter for converting the RGB data into YUV data; and
a data capture unit for retrieving the brightness value from the YUV data.

3. The apparatus of claim 2, wherein the digital signal processor further comprises:
a determining unit for determining whether the brightness value is within a predetermined brightness range;
a control unit for gradually adjust the light-emitting brightness of the light module when the brightness value is not within the predetermined brightness range, so as to let the brightness value be within the predetermined brightness range, wherein the control unit stops adjusting the light-emitting brightness of the light module when the brightness value is within the predetermined brightness range.

4. The apparatus of claim 3, wherein the predetermined brightness range has a predetermined upper limit and a predetermined lower limit, wherein the determining unit further determines whether the brightness value exceeds the predetermined upper limit when the brightness value is not within the predetermined brightness range, and when the brightness value does not exceed the predetermined upper limit, the control unit gradually increases the light-emitting brightness of the light module until the brightness value is greater than the predetermined lower limit.

5. The apparatus of claim 4, wherein the determining unit further determines whether the light module is turned on when the brightness value exceeds the predetermined upper limit, and when the light module is turned on, the control unit gradually decreases the light-emitting brightness of the light module until the determining unit determines that the brightness value is lower than the predetermined upper limit when the light module is not turned off.

6. The apparatus of claim 3, wherein the control unit is a PWM unit for sending at least one pulse wave to the light module, so that the light module controls the light-emitting brightness according to a pulse width of the pulse wave.

7. The apparatus of claim 2, wherein the digital signal processor further comprising:
a database for storing a lookup table, wherein the lookup table records a predetermined brightness range and a relation between the predetermined brightness range and at least one pulse width of a pulse wave;
a determining unit for determining whether the brightness value is within the predetermined brightness range; and
a control unit for sending the pulse wave based on the lookup table to the light module when the brightness value is not within the predetermined brightness range, so that the light module controls the light-emitting brightness according to the pulse width of the pulse wave.

8. A method for adjusting brightness, the method comprising:
(a) capturing image data;
(b) processing the image data and retrieving a brightness value from the processed image data, so as to adjust a light-emitting brightness of a light module according to the brightness value; and
(c) outputting the processed image data to a projection device, so that the projection device projects an optical image.

9. The method of claim 8, wherein the image data is RGB data, and the step (b) comprises:
converting the RGB data into YUV data; and
retrieving the brightness value from the YUV data.

10. The method of claim 8, wherein step (b) comprising:
determining whether the brightness value is within a predetermined brightness range;
gradually adjusting the light-emitting brightness of the light module when the brightness value is not within the predetermined brightness range, so as to let the brightness value be within the predetermined brightness range, and then stopping adjusting the light-emitting brightness of the light module when the brightness value is within the predetermined brightness range.

11. The method of claim 10, wherein the predetermined brightness range has a predetermined upper limit and a predetermined lower limit, and the step (b) further comprises:
determining whether the brightness value exceeds the predetermined upper limit when the brightness value is not within the predetermined brightness range; and
when the brightness value does not exceed the predetermined upper limit, gradually increasing the light-emitting brightness of the light module until the brightness value is greater than the predetermined lower limit.

12. The method of claim 11, wherein the step (b) further comprises:
determining whether the light module is turned on when the brightness value exceeds the predetermined upper limit; and
when the light module is turned on, gradually decreasing the light-emitting brightness of the light module until the determining unit determines that the brightness value is lower than the predetermined upper limit when the light module is not turned off.

13. The method of claim 10, wherein the step of gradually adjusting the light-emitting brightness of the light module comprises:
sending at least one pulse wave to the light module, so that the light module controls the light-emitting brightness according to a pulse width of the pulse wave.

14. The method of claim 8, wherein the step (b) further comprises:
preloading a lookup table, wherein the lookup table records a predetermined brightness range and a relation between the predetermined brightness range and at least one pulse width of a pulse wave;
determining whether the brightness value is within the predetermined brightness range; and
sending the pulse wave based on the lookup table to the light module when the brightness value is not within the predetermined brightness range, so that the light module controls the light-emitting brightness according to the pulse width of the pulse wave.

15. A document camera comprising:
a light module;
a sensor for capturing image data of an object;
a digital signal processor for processing the image data and for retrieving a brightness value from the processed image data, so as to adjust a light-emitting brightness of the light module according to the brightness value; and
an image output unit for outputting the processed image data to a projection device, so that the projection device projects an optical image of the object.

16. The document camera of claim 15, wherein the image data captured by the sensor is RGB data, and the digital signal processor comprises:
an image converter for converting the RGB data into YUV data; and
a data capture unit for retrieving the brightness value from the YUV data.

17. The document camera of claim 15, wherein the digital signal processor further comprises:
a determining unit for determining whether the brightness value is within a predetermined brightness range;
a control unit for gradually adjust the light-emitting brightness of the light module when the brightness value is not within the predetermined brightness range, so as to let the brightness value be within the predetermined brightness range, wherein the control unit stops adjusting the light-emitting brightness of the light module when the brightness value is within the predetermined brightness range.

18. The document camera of claim 17, wherein the predetermined brightness range has a predetermined upper limit and a predetermined lower limit, wherein the determining unit further determines whether the brightness value exceeds the predetermined upper limit when the brightness value is not within the predetermined brightness range, and when the brightness value does not exceed the predetermined upper limit, the control unit gradually increases the light-emitting brightness of the light module until the brightness value is greater than the predetermined lower limit when the light module is not turned off.

19. The document camera of claim 18, wherein the determining unit further determines whether the light module is turned on when the brightness value exceeds the predetermined upper limit, and when the light module is turned on, the control unit gradually decreases the light-emitting brightness of the light module until the determining unit determines that the brightness value is lower than the predetermined upper limit.

20. The document camera of claim 15, wherein the digital signal processor further comprising:
a determining unit for determining whether the brightness value is within the predetermined brightness range;
a database for storing a lookup table, wherein the lookup table records a predetermined brightness range and a relation between the predetermined brightness range and at least one pulse width of a pulse wave; and
a control unit for sending the pulse wave based on the lookup table to the light module when the brightness value is not within the predetermined brightness range, so that the light module adjusts the light-emitting brightness according to the pulse width of the pulse wave.
